(19) United States
(12) Patent Application Publication
(10) Pub. No.: US 2011/0008096 A1
(43) Pub. Date: Jan. 13, 2011

(54) LIQUID DISPENSER

(76) Inventors: Thomas J. COLEMAN, Abingdon, VA (US); William K. SCHLOTTER, IV, Fredericksburg, VA (US); Princess Ann COLEMAN, Abingdon, VA (US); Ann Marie SCHLOTTER, Fredericksburg, VA (US)

Correspondence Address: Thomas & Karceski, P.C., 536 GRANITE AVENUE, RICHMOND, VA, 23226, US

(21) Appl. No.: 12/835,158

(22) Filed: Jul. 13, 2010

Related U.S. Application Data
(60) Provisional application No. 61/224,929, filed on Jul. 13, 2009.

(51) Int. Cl. B43K 5/00

(52) U.S. Cl. 401/205

(57) ABSTRACT

A dispenser includes a reservoir adapted to contain a liquid medium, an applicator connected to the reservoir for application of the liquid medium from the reservoir, and a pump fluidically connected between the reservoir and the applicator to draw the liquid medium from the reservoir and provide the liquid medium to the applicator. The dispenser also includes an inlet tube fluidically connected between the pump and the reservoir to draw the liquid medium from the reservoir into the pump and an outlet tube fluidically connected between the pump and the applicator to dispense the liquid medium from the pump to the applicator.

### CROSS-REFERENCE TO RELATED APPLICATION(S)

This is a non-provisional patent application that relies for priority on U.S. Provisional Patent Application Ser. No. 61/224,929, filed on Jul. 13, 2009.

### FIELD OF THE INVENTION

The present invention concerns a liquid dispenser. While the present invention is contemplated to be used for dispensing liquid soaps, it may be employed for dispensing any liquid medium.

### DESCRIPTION OF THE RELATED ART

The prior art contains numerous examples of devices that may be used for personal hygiene and for cleaning. Sponges are one example.

The prior art, however, does not include examples of devices that combine a liquid medium reservoir with a suitable applicator.

As a result, there has developed a need for a device that includes a reservoir combined with an applicator.

### SUMMARY OF THE INVENTION

The present invention addresses one or more of the deficiencies noted above with respect to the prior art.

The present invention, therefore, provides for a dispenser that includes a reservoir adapted to contain a liquid medium, an applicator connected to the reservoir for application of the liquid medium from the reservoir, a pump fluidically connected between the reservoir and the applicator to draw the liquid medium from the reservoir and provide the liquid medium to the applicator, an inlet tube fluidically connected between the pump and the reservoir to draw the liquid medium from the reservoir into the pump, and an outlet tube fluidically connected between the pump and the applicator to dispense the liquid medium from the pump to the applicator.

In one contemplated embodiment, the reservoir includes an opening permitting liquid medium to be introduced into the reservoir.

In another contemplated embodiment, the pump includes an actuator, a plunger connected to the actuator, a chamber in which the plunger slidingly reciprocates, a first check valve disposed adjacent to an inlet to the chamber, and a second check valve disposed adjacent to an outlet from the chamber. Actuation of the actuator causes the liquid medium to be drawn into the chamber via the inlet and forced from the chamber via the outlet.

In a further embodiment, the first check valve is a ball valve biased into a closed position via a first spring and the second check valve is a ball valve biased into a closed position via a second spring.

According to one aspect of the present invention, an actuator spring biases the actuator in the pump such that the liquid medium is drawn into the chamber.

With respect to another aspect of the present invention, the inlet tube is connected to the chamber such that the liquid medium from the reservoir passes through the first check valve. Additionally, the outlet tube is connected to the chamber such that the liquid medium from the chamber passes through the second check valve.

In one embodiment of the present invention, a dispenser is provided with a coupling element attached to the reservoir, and a coupling recess provided in the applicator. The coupling element engages within the coupling recess to removably secure the applicator to the reservoir.

It is contemplated for the present invention that the applicator includes an applicator surface and a recess in the applicator surface, fluidically connected to the outlet tube, to receive the liquid medium supplied by the pump from the reservoir.

An aspect of the present invention anticipates that the applicator surface will be at least one of a sponge, a brush, a flexible material, or a mesh material.

It is also contemplated that the dispenser may include an applicator with a substrate and an applicator surface attached to the substrate.

According to one aspect of the invention, a grommet may be positionable in the recess to secure at least a part of the applicator surface to the substrate.

It is also contemplated that the pump is external to the reservoir and is disposed in a recess formed on a surface of the reservoir. Alternatively, the pump may be internal or external to the reservoir. The pump actuator is anticipated to be manually manipulable by a user.

In another embodiment of the present invention, the dispenser includes at least one eyelet connected to the reservoir and a handle connectable to the at least one eyelet. The handle may be of a telescoping design.

In another embodiment, a pump platform may support the pump. Here, the reservoir is removably attachable to the pump platform.

Where a pump platform is employed, the pump platform may include a coupling element and a coupling recess provided in the applicator. The coupling element may engage within the coupling recess to removably secure the applicator to the pump platform.

Other aspects of the invention will be made apparent from the discussion that follows.

### BRIEF DESCRIPTION OF THE DRAWINGS

The present invention will now be described in connection with the drawings appended hereto, in which:

FIG. 1 is a rear view of a first embodiment of the reservoir portion of the dispenser of the present invention;

FIG. 2 is a side view illustration of a first embodiment of a pump adapted for use in connection with the reservoir portion of the dispenser illustrated in FIG. 1;

FIG. 3 is a side view illustration of a portion of a second embodiment of a pump adapted for use in connection with the reservoir portion of the dispenser illustrated in FIG. 1;

FIG. 4 is a rear view of the first embodiment of the dispenser of the present invention in an assembled condition, showing the placement of the pump in relation to the reservoir;

FIG. 5 is a side view illustration of the dispenser illustrated in FIG. 4, showing the components in an exploded view;

FIG. 6 is a side view illustration of the dispenser illustrated in FIG. 5, with the components thereof being shown in an assembled condition;

FIG. 7 is a side view, exploded illustration of a second embodiment of a dispenser according to the present invention;

FIG. 8 is a side view illustration of a variation on the second embodiment of the dispenser illustrated in FIG. 7;

FIG. 9 is a side view illustration of a first embodiment of an applicator contemplated for use with the dispenser of the present invention;

FIG. 10 is a side view illustration of a second embodiment of an applicator contemplated for use with the dispenser of the present invention;

FIG. 11 is a side view, exploded illustration of a third embodiment of an applicator contemplated for use with the dispenser of the present invention;

FIG. 12 is a side view illustration of the third embodiment of the applicator depicted in FIG. 11, shown in an assembled condition;

FIG. 13 is a side view, exploded illustration of a fourth embodiment of an applicator contemplated for use with the dispenser of the present invention;

FIG. 14 is a side view illustration of the fourth embodiment of the applicator depicted in FIG. 13, shown in an assembled condition;

FIG. 15 is a side view, exploded illustration of one contemplated handle that may be employed together with the dispenser of the present invention;

FIG. 16 is a side view illustration of the handle depicted in FIG. 15, shown assembled with one embodiment of the dispenser of the present invention;

FIG. 17 is a side view illustration of a second embodiment of the handle of the present invention;

FIG. 18 is a side view, exploded illustration of still another embodiment of the dispenser of the present invention;

FIG. 19 is a side view illustration of a variation of the embodiment of the dispenser illustrated in FIG. 18, shown in an assembled condition;

FIG. 20 is a side view, exploded illustration of a further embodiment of the dispenser of the present invention;

FIG. 21 is a side view illustration of the embodiment illustrated in FIG. 20, shown in an assembled condition;

FIG. 22 is a top view of a reservoir for use with the dispenser depicted in FIGS. 20-21;

FIG. 23 is a side view illustration of still another embodiment of the present invention, in this case a separable reservoir with a construction differing from that of the prior embodiment;

FIG. 24 is a top view of the reservoir depicted in FIG. 23;

FIG. 25 is a side view of a pump platform according to this embodiment of the dispenser of the present invention; and

FIG. 26 is a side view, exploded illustration of the components of the dispenser illustrated in FIGS. 23-25.

### DETAILED DESCRIPTION OF EMBODIMENT(S) OF THE INVENTION

While selected embodiments of the invention are illustrated and described, the present invention is not intended to be limited to or by those embodiments. To the contrary, the embodiments illustrated and described are intended to provide a general description of the breadth and scope of the invention. Those skilled in the art will recognize variations and equivalents of the embodiments illustrated and described. Those variations and equivalents also are intended to be encompassed by the present invention.

With reference to the figures, like reference numbers are intended to refer to like structures.

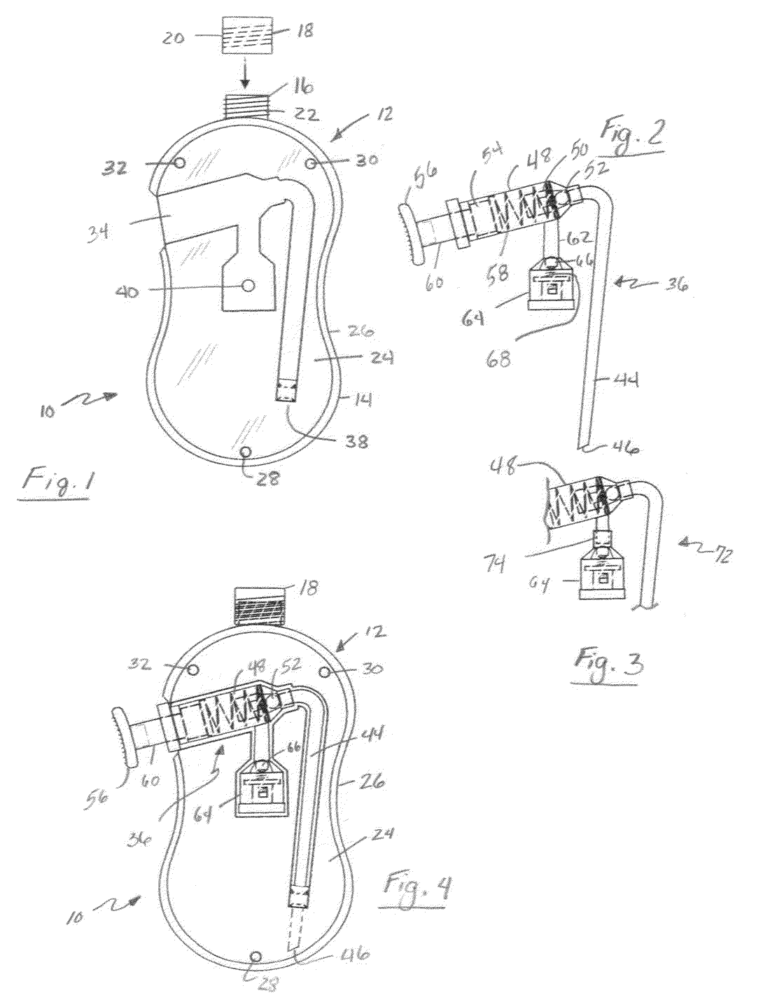

FIG. 1 provides a rear view of a first embodiment of the reservoir portion of the dispenser 10 of the present invention. The reservoir 12 includes a body 14 with a threaded opening 16. The body 14 is anticipated to be made from plastic, glass, rubber, or other suitable material capable of retaining liquid without leakage. The material may be flexible, rigid, or semi-rigid, as should be apparent to those skilled in the art. While glass may be used for the body 14, it is anticipated that plastic will present a more suitable material for the construction of the body 14.

The body 14 of the dispenser 10 is illustrated as an hour-glass shaped structure. However, the shape of the body 14 is not critical to the present invention. The shape may be round, oblong, an hourglass, oval, ellipsoidal, square, rectangular, polygonal, or amorphous. Any other suitable shape may be employed without departing from the scope of the present invention. Additionally, the body may be transparent, opaque, translucent, or any variation thereof. The transparency of the body 14 is not critical to operation of the present invention. A transparent body 14, however, offers the advantage of permitting the user to assess the amount of liquid in the reservoir 12, which has immediately apparent advantages over a non-transparent construction.

It is contemplated that the reservoir 12 may be provided with external gripping surfaces (not shown in this illustration) to facilitate grasping of the dispenser 10. The gripping surfaces may be molded into the body of the dispenser 10. Alternatively, the gripping surfaces may be added after components of the dispenser 10 are manufactured, as should be apparent to those skilled in the art. For example, the gripping members may be attached to the dispenser 10 via a suitable adhesive.

Additionally, the reservoir 12 may be provided with an inner membrane to assure a liquid-tight construction. The membrane is not required for practice of the present invention, but may be employed, as necessary. It is contemplated, for example, that an inner membrane may be preferred in instances where the liquid might tend to react with one or more of the materials that make up the reservoir 12 and/or associated components.

The threaded opening 16 provides access to the interior compartment within the body 14 of the reservoir 12. Since the dispenser 10 of the present invention is intended to be refillable by the user (at least in one contemplated embodiment), the threaded opening 16 provides a convenient location at the top end of the dispenser 10 for introducing the liquid medium preferred by the user. The threaded opening 16 is closed via a suitable cap 18.

It is anticipated that the threaded opening 16 will be formed integrally with the body 14 of the dispenser 10. However, an integral construction is not required for purposes of the present invention, as should be appreciated by those skilled in the art. The threaded opening 16 may be manufactured separately from the body 14 and be attached to the body 14 via suitable means including ultrasonic welding, adhesive, or the like.

The cap 18 may be manufactured from any suitable material including plastic, rubber, or the like, as should be appreciated by those skilled in the art. Like the body 14, the threaded opening 16, and other parts of the dispenser 10, the particular material selected is not critical to operation of the present invention.

It is noted that the cap 18 includes internal threads 20 that are intended to mate with the threads 22 on the threaded opening 16. While this construction is contemplated for the illustrated embodiment of the dispenser 10, a threaded connection is not required to practice the present invention. Any other type of suitable connection may be employed without departing from the scope of the present invention. Alternatively still, the cap 18 may be a snap/flip top cap, a pivotable cap, a dial cap, or any other contemplated variation thereon.

The body 14 is illustrated in FIG. 1 as having a back panel 24 that is connected to a front panel 26. The back panel 24 is provided with supports 28, 30, 32. The supports 28, 30, 32 project from the surface of the back panel 24 so that, when the dispenser 10 is laid on a surface, the supports 28, 30, 32 act as feet that separate the dispenser 10 from the surface on which it is placed. As may be appreciated by those skilled in the art, the supports 28, 30, 32 may be excluded without departing from the scope of the present invention.

If the reservoir 12 is constructed from a back panel 24 and a front panel 26, the two parts are contemplated to be connected to one another via a suitable sealing engagement to discourage leakage of the liquid medium from the reservoir 12. It is contemplated that the back panel 24 may be sealed to the front panel 26 with a suitable rubber O-ring, for example. With this construction, the back panel 24 may be removed from the front panel 26. In a variation of the illustrated embodiment, it is contemplated that the back panel 24 may be affixed to the front panel 26 via a suitable adhesive. Alternatively, the reservoir 12 may be a unitary construction without a separate back panel 24 and front panel 26.

As illustrated for the embodiment shown in FIG. 1, the back panel 24 includes a recess 34, which is adapted to receive a pump 36 (illustrated in FIG. 2). The recess 34 is contemplated to be as deep as the pump 36 is wide. With this construction, the pump 36 is fully recessed in the back panel 24 when inserted thereinto. As should be apparent, however, the recess 34 need not be so deep that the pump 36 is flush with the surface of the back panel 24. The recess 34 may be less deep than the pump 36 is wide without departing from the scope of the present invention.

One reason that the dispenser 10 may be provided with a removable back panel 24 is that the back panel 24 may be removed and replaced with a back panel 24 having a recess 34 with a configuration that differs from the configuration illustrated at least in FIG. 1. With such a construction, it is possible that the back panel 24 may be removed and substituted with a different back panel 24 to accommodate a pump 36 with a different configuration from the pump 36 illustrated in FIG. 2, for example.

It is noted that the reservoir 12 of the present invention may be constructed from a pliable material, as noted above. If made from a pliable material, the user may apply external pressure to the reservoir to assist with dispensing of the liquid medium contained therein. External pressure, in combination with operation of the pump 36 is anticipated to facilitate dispensing of the liquid medium contained within the reservoir 12. Alternatively, in a simplified construction, the pump 36 may be removed altogether so that the dispenser operates solely via pressure applied to the walls of the reservoir.

In one contemplated variation of the dispenser 10, the reservoir 12 may be compartmentalized into several chambers to permit the application of several different liquid media. The media may be expelled individually or together, as should be apparent to those skilled in the art. Where the reservoir 12 is compartmentalized, more than one pump 36 may be utilized.

With continued reference to FIG. 1, the recess 34 includes a supply opening 38 and a dispensing opening 40. As will be discussed in greater detail below, the supply opening 38 supplies the liquid medium to the pump 36 from the reservoir 12. The dispensing opening 40 provides the liquid medium from the pump 36 to a suitable applicator 42 (such as a cleaning head). One contemplated construction for the applicator 42 is illustrated in FIG. 5 and is discussed in greater detail with respect to FIG. 5.

Reference is now made to the pump 36 that is illustrated in FIG. 2. The pump 36 includes an inlet tube 44 (also referred to as a transfer tube 44), which is illustrated as an inverted, L-shaped structure. The inlet tube 44 is contemplated to be made from a suitable material such as plastic so that the inlet tube 44 may be easily manipulated into position in the recess 34 of the back panel 24 of the reservoir 12.

The tip 46 is inserted through the supply opening 38 so that the tip 46 is positioned within the interior of the reservoir 12. This is illustrated in FIG. 4, for example. The remainder of the transfer tube 44 remains exterior to the reservoir 12, within the recess 34 in the back panel 24.

The supply opening 38 may include a suitable sealing element such as an O-ring, or other elements that provides a sealing engagement with the exterior surface of the transfer tube 44. It is contemplated that the supply opening 38 will be constructed such that the transfer tube 44 may be removed therefrom. However, this construction is not required to practice the present invention.

It is contemplated, in an alternative embodiment, that the transfer tube 44 will be fixed so that it cannot be removed from the supply opening 38. In this contemplated arrangement, the transfer tube 44 may be affixed within the supply opening 38 by a suitable adhesive, for example. Other forms of connection also may be appreciated by those skilled in the art, whether the connection allows a removable engagement between the transfer tube 44 and the supply opening 38 or not.

The tip 46 of the transfer tube 40 may be angled as illustrated. This may assist with insertion of the tip 46 into the supply opening 38. This also may be beneficial in the instance where the side wall of the reservoir 12 is angled, as illustrated in FIG. 4. Alternatively, the angled tip 46 may be provided so that liquid medium may more easily flow into the transfer tube 44 from the reservoir 12. An angled tip 46 may be particularly beneficial where the tip 46 abuts against the interior surface of the reservoir 12, because the angled tip 46 may allow flow of the liquid medium even where the tip 46 is immediately adjacent to the interior surface of the reservoir 12.

At its other end, the transfer tube 44 is inserted into a dispensing body 48. The dispensing body 48, in the illustrated embodiment, includes a primary chamber 50 and a check valve 52. The check valve 52 is illustrated as a ball that abuts against the end of the transfer tube or the structure into which the transfer tube 44 is affixed. The dispensing body 48 also includes a plunger 54, a plunger actuator 56, and a spring 58.

The plunger 54 is connected to the plunger actuator 56 via a plunger stem 60. The plunger 54 is positioned within the dispensing body 48 such that the spring 58 biases the plunger 54 in the distal position that is illustrated in FIG. 2. The spring 58 is illustrated as a coil spring, but the spring 58 may take any suitable form for operation of the pump 36.

The dispensing body 48 is connected to an outlet tube 62. The outlet tube 62 is connected fluidically to the interior of the dispensing body 48. The outlet tube 62 connects to a secondary chamber 64 that includes a second check valve 66 and a second spring 68. The second check valve 66 is a ball valve as is the case with the first check valve 52. The second spring 68 biases the second check valve 66 in a closed position, as illustrated in FIG. 2. The secondary chamber 64 is connected to an outlet tube 70, which is illustrated in FIG. 5. The outlet tube 70 is fluidically connected to the exterior of the reservoir 12 and provides the liquid medium from the reservoir 12 to the exterior, specifically the applicator 42 attached thereto.

With reference to FIGS. 1 and 2, the operation of the pump 36 is as follows. When a user depresses the plunger actuator 56, the plunger 54 is forced from the distal position toward the check valve 52. The increased pressure in the dispensing body 48 causes the first check valve 52 to close, thereby sealing the interior chamber, or primary chamber, in the dispensing body 48. This prevents fluid from being ejected from the primary chamber through the transfer tube 44. Pressure on the plunger 54 also causes the second check valve 66 to open by applying pressure against the second spring 68 in the secondary chamber. This permits fluid to pass through the secondary chamber and to exit via the outlet tube 70. This causes the liquid medium, i.e., the liquid soap, to be dispensed onto the applicator 42.

Release of pressure on the plunger actuator 56 permits the first spring 58 to expand. Release of pressure on the plunger actuator 56 also permits the second spring 68 to expand. When the second spring 68 expands, the second check valve 66 closes, preventing fluid from being drawn from the secondary chamber 64 back through the outlet tube 62. With pressure on the plunger actuator 56 released, the first spring 58 applies pressure on the plunger 54 in the dispensing body 48 to move the plunger 54 into the distal position. The pressure developed by this action opens the first check valve 52, permitting fluid to be drawn through the transfer tube 44 into the primary chamber within the dispensing body.

As may be appreciated from the foregoing, repeated actuation of the plunger actuator 56 will cause the liquid medium from the reservoir to be incrementally forced out of the outlet tube 70 onto the applicator 42, in aliquot amounts selected by the user. The user, therefore, may apply a preferential amount of the liquid medium onto the applicator 42 by repeated depression of the plunger actuator 56.

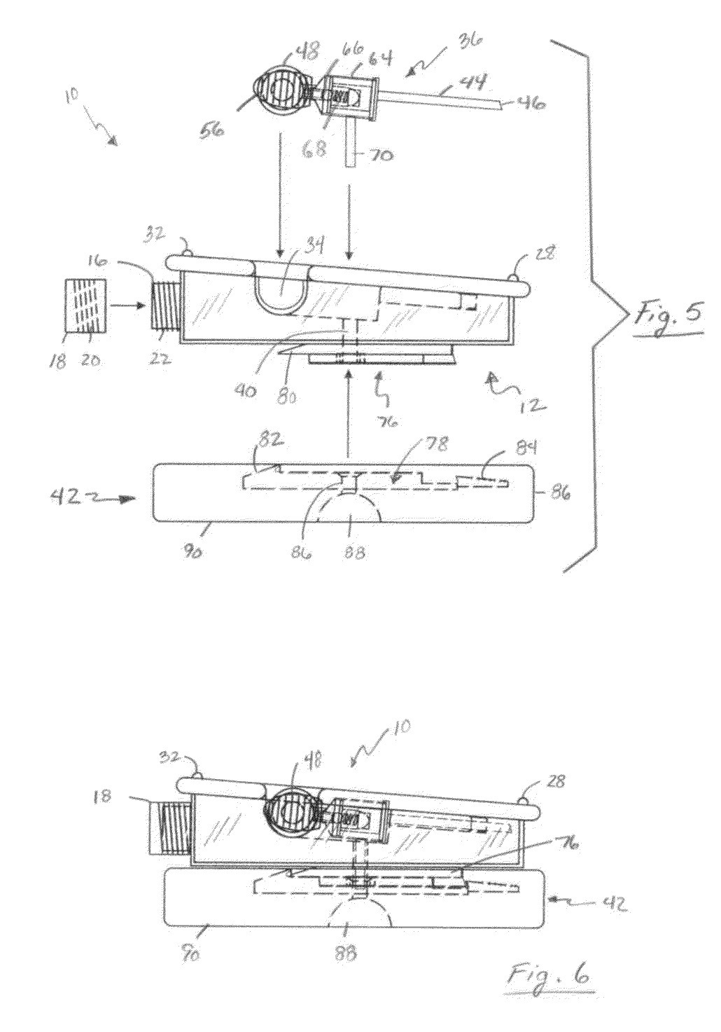

FIG. 3 is a side view illustration of a variation on the pump 36 illustrated in FIG. 2. In FIG. 3, the pump 72 differs from the pump 36 in that there is a connector 74 between the dispensing body 48 and the secondary chamber 64. The outlet tube 62 is inserted into the connector 74 to fluidically connect the dispensing body 48 with the secondary chamber 64. The connector 74 may provide a releasable connection between the outlet tube 62 and the secondary chamber 64. Alternatively, the connector 74 may be sealed via any suitable means including adhesive, as should be apparent to those skilled in the art.

FIG. 4 is a rear view illustration of the dispenser 10 of the present invention. In this illustration, the reservoir 12 and the pump 36 are illustrated in an assembled condition to show how the various elements of the dispenser 10 connect to one another.

FIG. 5 is a side view illustration of the dispenser 10 of the present invention, as illustrated in FIG. 4. In this illustration, the three main components of the dispenser 10 are immediately apparent. The pump 36 is inserted into the reservoir 12. The applicator 42 attaches to the reservoir 12. As illustrated, the pump 36 is located on the rear side of the dispenser 10 and the applicator 42 is attached to the front surface of the reservoir 12.

On its front surface, the reservoir 12 includes a coupling protrusion 76 that mates with a coupling recess 78 on the rear side of the applicator 42. The coupling member 76 includes an angled surface 80 that engages with a chamfered surface 82 in the coupling recess 78. A lever system 84 is provided to permit the applicator 42 to be releasably attached to the reservoir 12. The lever system 84 may be accessible from the side edge 86 of the applicator 42.

It is noted that the coupling member 76 and the coupling recess 78 are not required for operation of the present invention. Other attachment means also are contemplated. For example, attachment may be accomplished via hook and loop fasteners (also known as Velcro®), a slide lock mechanism, a twist lock mechanism, screws, magnets, or any type of male/female connection, among others. With reference to the coupling member 76 and the coupling recess 78, while one contemplated embodiment is illustrated, the present invention is not limited to the specific construction shown. As should be appreciated by those skilled in the art, there are innumerable different constructions that may be employed to removably secure the applicator 42 to the reservoir 12.

As illustrated, the applicator 42 includes a channel 86 that opens into a concave recess 88 on the front surface 90 thereof. The liquid medium that is dispensed from the outlet tube 70 is deposited into the concave recess 88 in the applicator 42 for application as directed by the user.

In addition, with respect to the lever system 84, the details of the lever system 84 are not critical to operation of the present invention. It is contemplated that the lever system 84 will provide releasable securement of the applicator 42 to the reservoir 12. It is contemplated that a lever system 84 is not needed to secure the applicator 42 to the reservoir 12. Other means may be employed without departing from the scope of the present invention, such as a button-operated system.

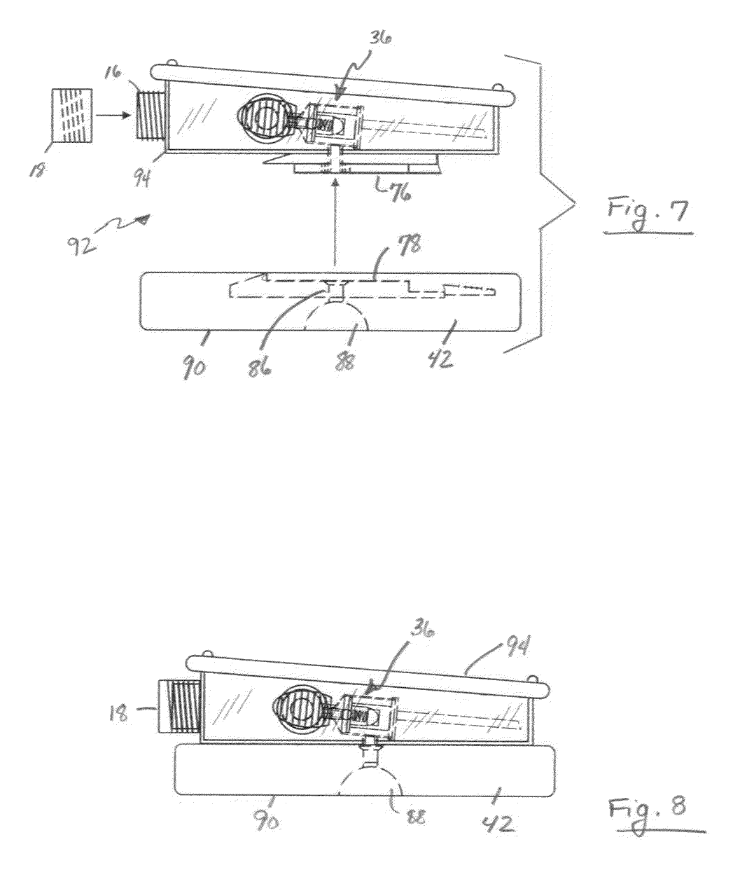

FIG. 6 provides a side view of the dispenser 10 of the present invention. As with FIG. 4, this illustration shows the pump 36, the reservoir 12, and the applicator 42 in an assembled condition to facilitate an understanding of the present invention.

With reference to the dispenser 10 of the present invention, it is noted that the applicator 42 may take any number of forms. It is contemplated, for example, that the applicator 42 that is illustrated in FIGS. 5 and 6, for example, may be a sponge-type applicator. As will be made apparent from the discussion that follows, it is contemplated that the applicator 42 may be of any number of different forms and constructions without departing from the scope of the present invention. For example, the sponge material may be substituted with an exfoliating material, pouf, mesh, paper, nylon, acrylic, a brush, plastic, steel wool, an abrasive material, a polishing material, or any other suitable natural or synthetic material. It is also contemplated that the material for the applicator 42 may be a combination of materials. For example, a pattern may be applied to the surface of the applicator 42 via embroidering, printing, etc.

The applicator 42 may have any shape, as should be apparent to those skilled in the art. The applicator 42, moreover, may be used for any suitable purpose including, but not limited to cleaning, scrubbing, washing, exfoliating, waxing, bathing, or the like. In this regard, the liquid medium may be any type of substance including, but not limited to soap, wax, paste, abrasive liquids, and others. With such a wide variety of materials, the dispenser 10 may be used for personal hygiene, cleaning of various surfaces, window washing, scrubbing, etc.

FIG. 7 illustrates a second contemplated embodiment of the present invention. In FIG. 7, a dispenser 92 is illustrated. The dispenser 92 is similar to the dispenser 10 except that the pump 36 is internal to the reservoir 94 and is not provided in any recess 34 as in the prior embodiment. The applicator 42 is contemplated to have the same construction as in the prior embodiment.

FIG. 8 is a side view illustration of an assembled version of a variation of the dispenser 92 according to a variation on the second embodiment illustrated in FIG. 7. Here, the applicator 42 is attached permanently to the reservoir 94. As shown, this embodiment excludes the coupling protrusion 76 and the coupling recess 78. As such, the applicator 42 is not intended to be removed from the reservoir 94, as is the case with the variation illustrated in FIG. 7.

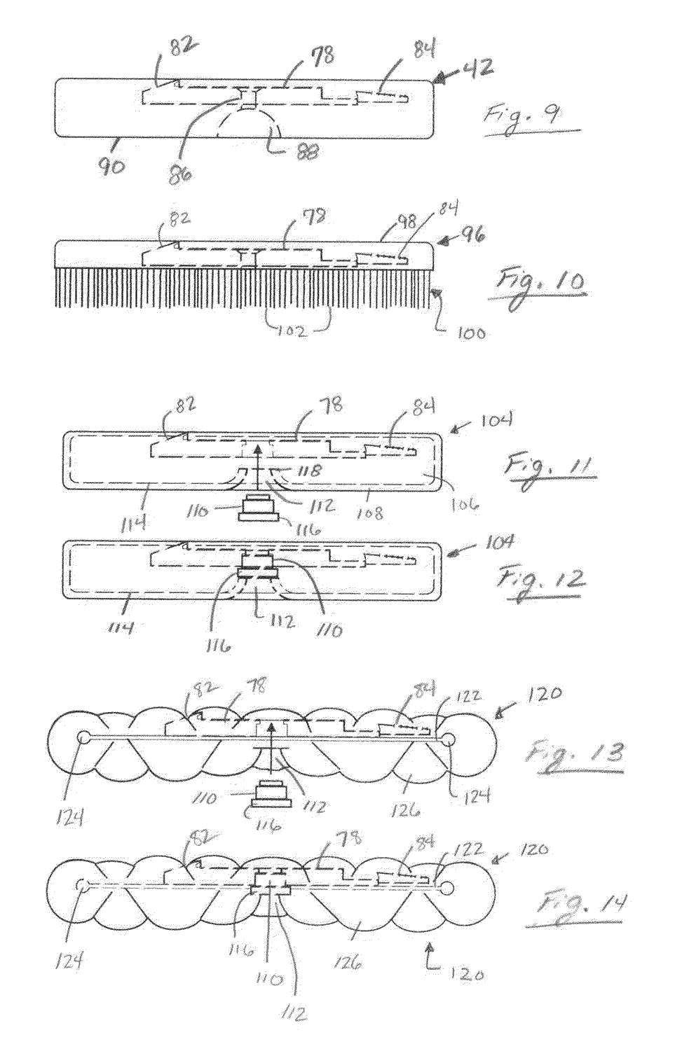

FIG. 9 is a side view illustration of a first embodiment of the applicator 42 of the present invention, as discussed above. As noted, the applicator 42 is contemplated to be a sponge-type device, as should be appreciated by those skilled in the art.

FIG. 10 is a side view illustration of an applicator 96 according to a second contemplated embodiment. In this embodiment, the applicator 96 includes a substrate 98. The substrate 98 may be made from any suitable material including plastic. As in the prior embodiment, the substrate 98 includes a coupling recess 78 that permits removable attachment to the reservoir 12. The coupling recess 78 also includes the chamfered surface 82 and the lever system 84, as discussed above.

The applicator 96 that is depicted in FIG. 10 includes a brush 100 that is made up of individual bristles 102 or groups of bristles 102. Other arrangements for the bristles 102 also are contemplated to fall within the scope of the invention and FIG. 10 merely provides a simplistic depiction of one contemplated embodiment.

FIGS. 11 and 12 depict another embodiment of an applicator 104 that is contemplated for the present invention. In this embodiment, the applicator 104 includes a substrate 106 that is encapsulated (or surrounded) by a flexible material 108. As in the prior embodiments, the substrate 106 may be made from any suitable material including plastic and rubber. As also is apparent, the substrate 106 may include the coupling recess 78, chamfered surface 82 and lever system 84. As in the prior embodiments, the lever system 84 permits removable attachment of the applicator 106 from the reservoir 12.

With respect to the flexible material 108, it is contemplated that this material will be absorbent, but this is not required to practice the present invention. The flexible material 108 may be a sponge material or, alternatively, could be a chamois or chamois-type material as should be appreciated by those skilled in the art. The flexible material 108 is anticipated to cover most or all of the exposed surfaces of the substrate 106.

In the embodiment illustrated in FIGS. 11 and 12, the applicator 104 also includes a grommet 110 that is inserted into an opening 112 in the front surface 114 of the applicator 104. The grommet 110 includes a flanged lip 116. The flanged lip 116 on the grommet 110 is provided to secure the edges 118 of the flexible material 108 around the opening 112. As such, the grommet 110 prevents the flexible material 108 from becoming dislodged from around the opening 112 in the applicator 104.

As is apparent, FIG. 11 illustrates the applicator 104 with the grommet 110 removed. In FIG. 12, the grommet 110 has been inserted into the opening 112 to secure the edges 118 of the flexible material 108.

FIGS. 13 and 14 illustrate yet another contemplated embodiment of an applicator 120. In these illustrations, the applicator 120 includes a substrate 122 that is thinner in cross-section than the prior embodiments. The substrate 122 includes beaded edges 124, as shown. A mesh material 126 is secured to the substrate 122, around the beaded edges 124. The mesh material 126 is contemplated to be a plastic mesh capable of retaining the liquid medium therein. The mesh material 126 also may provide a sufficiently abrasive surface to facilitate cleaning of the user's person, in the case where the applicator is intended to apply liquid soap as the liquid medium.

As in prior embodiments, it is contemplated that the applicator 120 will include the coupling recess 78 therein. The coupling recess 78 may include a chamfered surface 82, as in the prior embodiments. In addition, a lever system 84 may be provided to permit the applicator 120 to be removably attached to the reservoir 12.

As discussed in connection with the embodiment illustrated in FIGS. 11 and 12, the applicator 120 may be provided with a grommet 110 that is insertable into an opening 112. As in the prior embodiment, the grommet 110 may include a flanged lip 116 that engages the flexible mesh 126 and holds the flexible mesh 126 against the substrate 122. FIG. 11 illustrates the grommet 110 in a position before insertion into the opening 112. FIG. 12 illustrates the grommet 110 after being inserted into the opening 112.

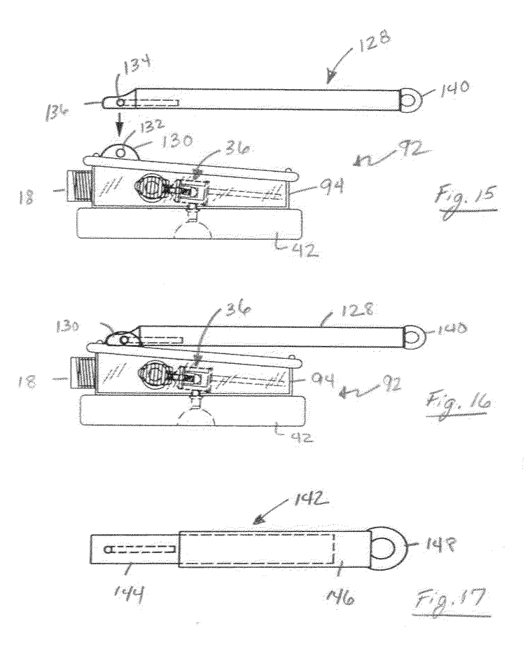

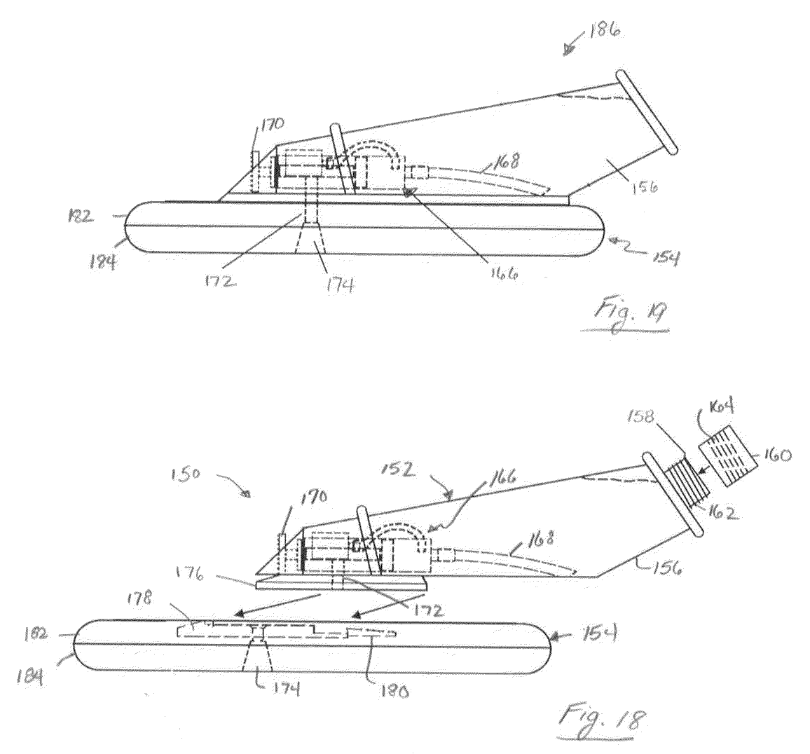

FIG. 15 is a side view illustration of a further aspect of the present invention, a detachable handle 128. The detachable handle 128 is described in connection with the dispenser 92 that is illustrated in FIGS. 7 and 8. While the handle 128 is described in connection with the dispenser 92, the handle 128 may be used in connection with any other of the embodiments of the dispenser of the present invention. In other words, the handle 128 is not intended to be limited solely to use in connection with the dispenser 92.

Before discussing the specific aspects of the handle 128 that is discussed in connection with FIGS. 15-17, it is noted that the handle 128 (and associated components) may take any shape or be made in any size that is suitable for use with the various embodiments of the dispenser 92 of the present invention. In one contemplated embodiment, for example, the handle 128 may be telescopic so that it may be lengthened for greater reach by the user.

It is contemplated that the handle 128 may serve any number of different uses. For example, where the dispenser 92 is utilized for personal hygiene, the handle 128 may permit the user to scrub his or her back. Where the dispenser 92 is used for other cleaning purposes, the handle 128 permits the user to reach areas (of a car or house, for example) that would otherwise require a ladder or step stool. In addition, it is noted that while the handle 128 is illustrated as being of a length commensurate with the size of the dispenser 92, this is not required to practice the present invention.

So that the handle 128 may be removably attached to the reservoir 94, the reservoir 94 is provided with one or more eyelets 130. The eyelets 130 are attached to the rear surface of the reservoir 94 in the illustrated embodiment. As should be appreciated by those skilled in the art, the eyelets 130 may be provided on any part of the reservoir 94 or even the applicator 42, as required or desired.

The eyelets 130 are anticipated to be made from the same material as the reservoir 94. In addition, it is anticipated that the eyelets 130 will be molded together with the reservoir 94. However, this is not required to practice the present invention. The eyelets 130 may be affixed to the reservoir 94, either permanently or removably, after manufacture of the reservoir 94, as should be appreciated by those skilled in the art.

The eyelets 130 include holes 132 that engage with a pin 134 associated with a first end 136 of the handle 128. The second end 138 of the handle 128 may include an eyelet 140 that permits the dispenser 92 to be hung on a wall, in a shower, or at any other suitable storage location.

FIG. 16 illustrates the handle 128 as it appears when connected to the reservoir 94.

FIG. 17 is a side view illustration of a handle 142 according to another embodiment of the present invention. Here, the handle 142 includes an inner, telescoping member 144 and an outer telescoping member 146. An eyelet 148 is provided for the same purpose as the eyelet 140 in the prior embodiment.

As should be apparent to those skilled in the art and as should also be apparent from FIG. 17, the outer telescoping member 146 slidingly engages the inner telescoping member 144. In the embodiment illustrated, the inner telescoping member 144 slides within the outer telescoping member 146 so that the length of the handle 142 may be adjusted. The inner telescoping member 144 may lockably engage the outer telescoping member 146 in any suitable manner, as should be appreciated by those skilled in the art. The exact locking mechanism is not critical to operation of the present invention and is, therefore, not illustrated.

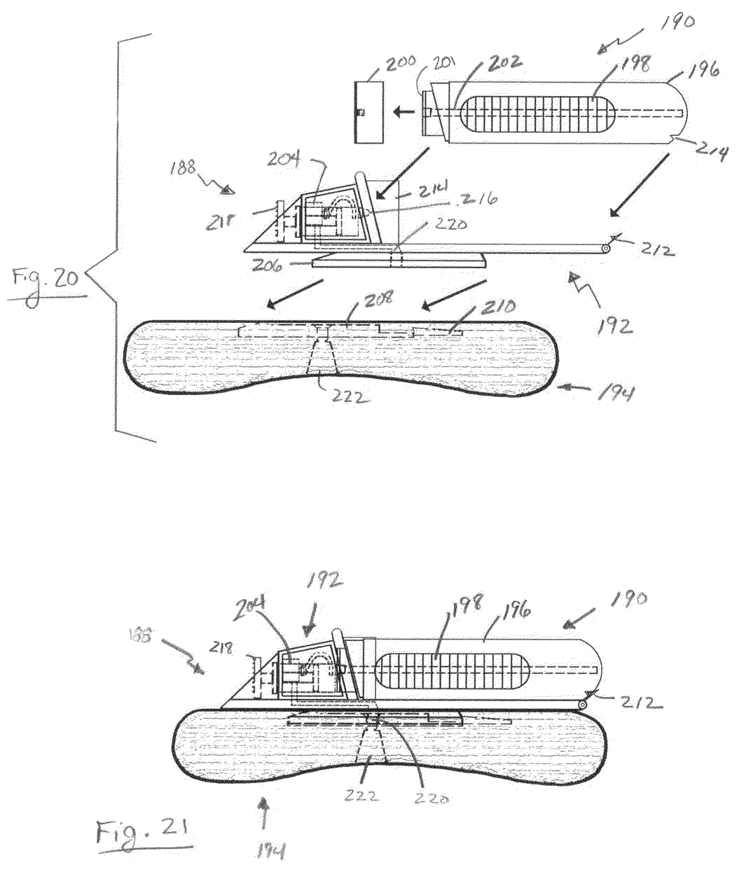

FIG. 18 is a side view illustration of yet another embodiment of a dispenser 150 according to the present invention. This particular embodiment of the dispenser 150 may be used for any purpose. However, this particular embodiment is anticipated to contain liquid wax, such as the type that might be applied to a floor or car. As should be apparent, however, the dispenser 150 may contain liquid soap, as in the prior embodiments, or may contain any other type of dispensable liquid medium.

As in the prior embodiments, the dispenser 150 includes a reservoir 152 and an applicator 154. The reservoir 152 in this embodiment includes an angled body portion 156 with a filler neck 158. The filler neck 158 may be closed with a suitable cap 160. In this embodiment, the filler neck 158 includes threads 162 that engage with threads 164 on the cap 160. The cap may take any form, as discussed in connection with the cap 18.

As in the embodiment illustrated in FIGS. 7 and 8, the dispenser 150 includes an internal pump 166 with a filler tube 168 and a plunger actuator 170. Fluid from the reservoir 152 is discharged from an outlet tube 172 into a recess 174 in the applicator 154. The applicator 154 attaches to the reservoir 152 via a coupling element 176 and coupling recess 178. So that the applicator 154 is removable from the reservoir 152, a lever system 180 may be provided to permit removable securement of the applicator 154 to the reservoir 152.

The applicator 154 includes a substrate 182 and an application surface 184. As in prior embodiments, the substrate 182 may be made from any suitable material including plastic and rubber. The application surface 184 also may be made from any suitable material, including a sponge, sponge-like material, mesh, pouf, chamois, and/or steel wool, to name a few of the possibilities. The application surface 184 also may combine plural materials, as discussed above.

FIG. 19 illustrates a variation of the dispenser 150 illustrated in FIG. 18. To distinguish it from the dispenser 150, the dispenser in FIG. 19 is indicated by the reference number 186. Here, the applicator 154 is affixed to the reservoir 152 without the coupling element 176 and the coupling recess 178. In other words, the applicator 154 is non-removably affixed to the reservoir 152. In addition, the filler neck 158 is excluded. In this embodiment, therefore, the reservoir 152 is not intended to be refillable. Instead, the dispenser 186 is contemplated to be disposable.

FIG. 20 illustrates one further embodiment of a dispenser 188 of the present invention. Here, the dispenser 188 is shown in a side view, exploded illustration.

The dispenser 188 includes a reservoir 190, a pump platform 192, and an applicator 194.

The reservoir 190 includes a hollow body 196 with gripping members 198 disposed thereon. The gripping members 198 either may be integrally fashioned into the surface of the hollow body 196 or may be applied separately thereto, for example, with an adhesive.

In this embodiment, the reservoir 190 includes a cap 200 with an inlet tube 202 extending from the cap 200 into the interior of the hollow body 196. The cap 200 fits onto the hollow body 196 and also connects to the pump platform 192. When connected to the pump platform 192, the inlet tube 202 feeds the liquid medium to the pump 204.

In this embodiment, the pump 204 is disposed on the pump platform 192, rather than being recessed into the reservoir or incorporated into the interior of the reservoir. As such, this particular embodiment provides for a quick change between different liquid media by removing one reservoir 190 and replacing it with another.

The pump platform 192 is provided with a coupling member 206 that engages a coupling recess 208 in the applicator 194. A lever system 210 may be provided so that the applicator 194 is removably connectable to the pump platform 192. This arrangement is intended to be the same as or similar to the arrangements discussed previously. As also previously discussed, there are numerous alternative connection arrangements that may be employed without departing from the scope of the present invention.

In the embodiment illustrated in FIG. 20, a connector 212 on the pump platform 192 engages a notch 214 in the reservoir 190 to secure the reservoir 190 on the pump platform 192. The cap 200 on the reservoir 190 is removed to expose the outlet 201 of the reservoir 190. The outlet 201 is then inserted into a cap recess 214 on the pump platform 192. The cap recess 214 secures the outlet 201 in place. Alternatively, the cap 200 may be left on the reservoir 190 and may include an opening to engage with a nozzle tip 216 on the pump platform 192. Alternatively, the nozzle tip 216 may include a piercing device for one contemplated embodiment of the invention.

The pump 204 is intended to operate in the same fashion as the pumps described in prior embodiments. Specifically, the user depresses an actuator 218 to draw the liquid medium from the reservoir 190 and pump the liquid medium through an outlet tube 220 to a recess 222 in the applicator 194.

In the illustrated embodiment, the applicator 194 is contemplated to be a sponge or sponge-like material. As discussed above, any number of materials may be employed for the applicator 194. For example, the applicator 194 may be made from paper, cloth, a chamois material, steel wool, a pouf, a mesh, or a combination of these materials, among others. As with prior embodiments, the applicator 194 may include a rigid, semi-rigid or flexible core surrounded by a cloth material, or the like.

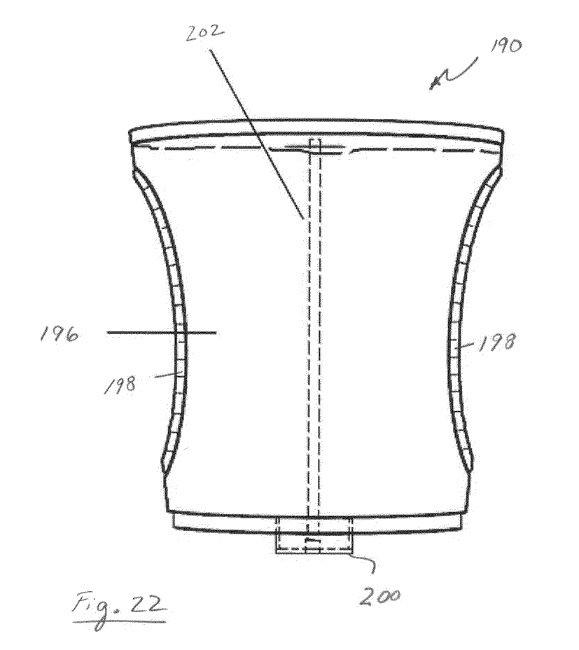

FIG. 21 is a side view illustration of the dispenser 188 illustrated in FIG. 20. Here, the dispenser 188 is shown in an assembled state. As in prior embodiments, the pump 204 discharges the liquid medium through an outlet tube 214 to a recess 216 in the applicator 194.

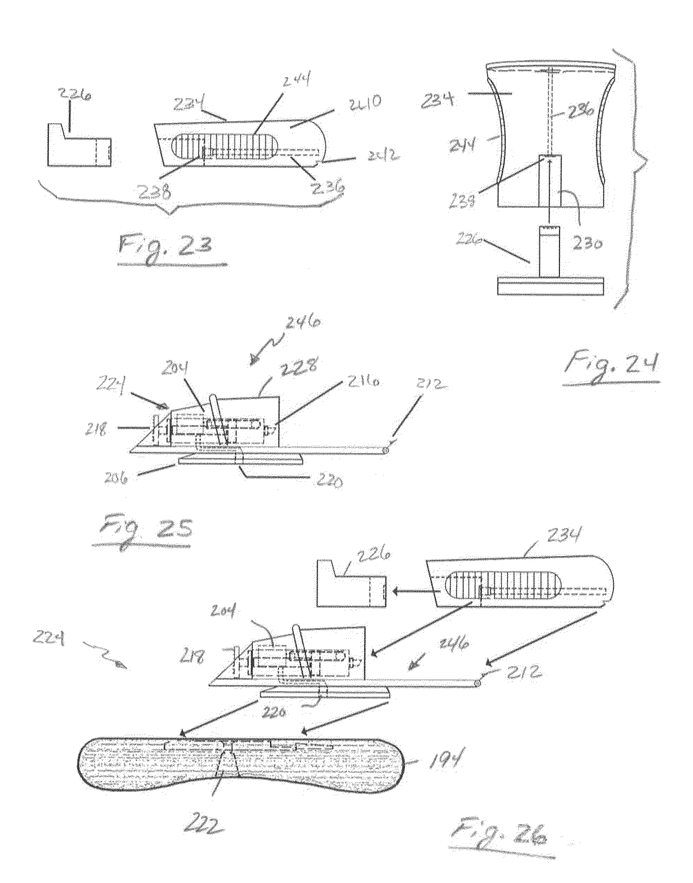

FIG. 22 is a top view of the reservoir 190 depicted in FIGS. 20-21. The top view illustrates the hour-glass shape of the reservoir 190. In addition, the size and shape of the cap 200 is more clearly depicted.

FIGS. 23-26 illustrate still one further embodiment of the present invention. Here, a dispenser 224 is shown. The dispenser 224 is similar to the dispenser 188, except that the cap 226 and cap recess 228 are shaped differently, among other changes.

The cap 226 is T-shaped and inserts into a slot 230 in the reservoir 234. The inlet tube 236 extends from a forward wall 238 that is defined by the slot 230. The reservoir 234 includes a hollow body 240 with a connector 242 as in the prior embodiment. The reservoir 234 includes gripping members 244, as in the prior embodiment.

As in the prior embodiment, the cap 226 is intended to be removed from the reservoir 234 before the reservoir 234 is installed on the pump platform 246. Alternatively, the cap 226 may be designed to remain on the reservoir 234 during installation on the pump platform 246.

The pump platform 246 is essentially the same as the pump platform 192, except that the cap recess 228 is shaped to accommodate the reservoir 234, including the slot 230.

As should be apparent from the drawings, and as should be apparent to those skilled in the art, the dispensers 10, 92, 150, 186, 188, 224 and the variations thereon may be used in a vertical orientation or in a horizontal orientation. For example, the dispenser 10 is contemplated to be used in a vertical orientation, which is why the transfer tube extends to the bottom of the reservoir 12 opposite to the threaded opening 16. The dispenser 150, on the other hand, is contemplated to be used primarily in a horizontal orientation.

As noted herein, the dispenser 10 is contemplated to be used for cleaning and, therefore, to contain liquid soap. The dispenser 150, on the other hand, is contemplated to be used for dispensing wax, for example, when a user waxes a car or floor. As a result, the dispenser 150 is expected to contain liquid wax.

As should be appreciated by those skilled in the art, the exact composition of the liquid contained within the dispenser 10, 92, 150, 186, 188, 224 is not critical to the present invention. In addition, the orientation of the dispenser 10, 92, 150, 186, 188, 224 also is not critical to the present invention.

Within this disclosure, it is noted that the term “cleaning head” and “dispensing head” have been employed to refer to the structures attached to the associated liquid reservoirs. These heads are applicators in the generic sense. The term “applicator” is, therefore, used to refer to any and all of the different structures that may be attached to a reservoir for purposes of dispensing and applying liquid media, such as soap or wax.

As should be apparent from the foregoing, the present invention is not limited to liquid soap or to wax. Any liquid may be dispensed from the dispensers 10, 92, 150, 186, 188, 224 of the present invention (and their variations) without departing from the scope of the present invention.

As noted above, the present invention is not intended to be limited to the embodiments shown or described. To the contrary, the embodiments are intended to illustrate the broad scope of the present invention.

What is claimed is:

1. A dispenser, comprising:
a reservoir adapted to contain a liquid medium;
an applicator connected to the reservoir for application of the liquid medium from the reservoir;
a pump fluidically connected between the reservoir and the applicator to draw the liquid medium from the reservoir and provide the liquid medium to the applicator;
an inlet tube fluidically connected between the pump and the reservoir to draw the liquid medium from the reservoir into the pump; and
an outlet tube fluidically connected between the pump and the applicator to dispense the liquid medium from the pump to the applicator.

2. The dispenser of claim 1, wherein the reservoir comprises:
an opening permitting liquid medium to be introduced into the reservoir.

3. The dispenser of claim 1, wherein the pump comprises:
an actuator;
a plunger connected to the actuator;
a chamber in which the plunger slidingly reciprocates;
a first check valve disposed adjacent to an inlet to the chamber; and
a second check valve disposed adjacent to an outlet from the chamber;
wherein actuation of the actuator causes the liquid medium to be drawn into the chamber via the inlet and forced from the chamber via the outlet.

4. The dispenser of claim 3, wherein the first check valve comprises a ball valve biased into a closed position via a first spring and wherein the second check valve comprises a ball valve biased into a closed position via a second spring.

5. The dispenser of claim 3, further comprising an actuator spring that biases the actuator such that the liquid medium is drawn into the chamber.

6. The dispenser of claim 3, wherein the inlet tube is connected to the chamber such that the liquid medium from the reservoir passes through the first check valve.

7. The dispenser of claim 3, wherein the outlet tube is connected to the chamber such that the liquid medium from the chamber passes through the second check valve.

8. The dispenser of claim 1, further comprising:
a coupling element attached to the reservoir; and
a coupling recess provided in the applicator;
wherein the coupling element engages within the coupling recess to removably secure the applicator to the reservoir.

9. The dispenser of claim 1, wherein the applicator comprises:
an applicator surface; and
a recess in the applicator surface, fluidically connected to the outlet tube, to receive the liquid medium supplied by the pump from the reservoir.

10. The dispenser of claim 9, wherein the applicator surface comprises:
at least one of a sponge, a brush, a flexible material, or a mesh material.

11. The dispenser of claim 9, wherein the applicator further comprises:
a substrate; and
an applicator surface attached to the substrate.

12. The dispenser of claim 11, wherein the applicator surface comprises:
at least one of a sponge, a brush, a flexible material, or a mesh material.

13. The dispenser of claim 12, further comprising:
a grommet positionable in the recess to secure at least a part of the applicator surface to the substrate.

14. The dispenser of claim 1, wherein the pump is external to the reservoir and is disposed in a recess formed on a surface of the reservoir.

15. The dispenser of claim 1, wherein the pump is external to the reservoir.

16. The dispenser of claim 1, wherein the actuator is manually manipulable by a user.

17. The dispenser of claim 1, further comprising:
at least one eyelet connected to the reservoir; and
a handle connectable to the at least one eyelet.

18. The dispenser of claim 17, wherein the handle is telescopic.

19. The dispenser of claim 1, further comprising a pump platform supporting the pump, wherein the reservoir is removably attachable to the pump platform.

20. The dispenser of claim 19, wherein the pump platform further comprises:
a coupling element; and
a coupling recess provided in the applicator;
wherein the coupling element engages within the coupling recess to removably secure the applicator to the pump platform.
